(19) United States
(12) Patent Application Publication
(10) Pub. No.: US 2006/0143228 A1
(43) Pub. Date: Jun. 29, 2006

(54) System and method for selecting qualified job applicants

(75) Inventors: Daniel Ruben Odio-Paez, Washington, DC (US); Dwight Davis Dunton III, Alexandria, VA (US)

Correspondence Address: FLESHNER & KIM, LLP, P.O. BOX 221200, CHANTILLY, VA, 20153, US

(73) Assignee: XY Concepts, LLC

(21) Appl. No.: 11/023,616

(22) Filed: Dec. 29, 2004

(51) Int. Cl. G06F 7/00

(52) U.S. Cl. 707/104.1

(57) ABSTRACT

A system and method of selecting qualified job applicants from a source hosting or advertising job openings, the system and method comprising a pre-screening/qualifying stage, wherein a job applicant is evaluated on responses given to a questionnaire electronically forwarded by the employer, based on an advertised job position; and an interview stage, wherein the job applicant is selected for employment based the quality, performance, and completion of at least one task pertaining to the advertised job position.

### BACKGROUND OF THE INVENTION

1. Field of the Invention

The present invention relates to a system and method of selecting qualified job applicants from sources hosting or advertising job openings, and more particularly, to a novel system and method of selecting qualified job applicants where job applicants are pre-screened and filtered through based on their responses to questions related to a job opening, and selected for employment based on the quality, performance, and completion of one or more assigned tasks during an interview.

2. Background of the Related Art

Many methods have been used by employers for selecting or hiring qualified job applicants. Traditionally, the common method of employers has been direct advertising in newspapers or magazines, targeting individuals with specific skills, knowledge and/or experience. A typical job advertisement generally includes a brief description of the available position, and the contact information of the employer. Job applicants apply for the advertised position by sending their resumes directly to the employer by facsimile, regular mail or e-mail. An employer will usually have a person in its employment or human resources department screen the resumes to identify the applicants best suited for the position.

This traditional method, however, is very inefficient. For instance, after the resumes are received by the company they must be manually organized and screened, a person in the company's recruitment or human resources department may need to spend a significant amount of time every day performing this task. In a large corporation having many positions becoming available on a daily basis, it may be necessary for several people to devote most of their time to organizing and screening applicants' resumes. Furthermore, because a large amount of resumes may be received, the task of organizing and screening those resumes may be particularly onerous and thus, a certain resume may be overlooked or mishandled. As a result, a candidate who is well suited for a position may never be considered.

Recently, employers have begun using computer networks to post job openings. For instance, a company may set up its own home page (“web page”) on the World Wide Web (the “Internet”) for posting job opportunities. Internet subscribers determine which positions employers have available, and send a resume to the company via regular mail, facsimile or e-mail.

Although a web page can be a useful tool in enabling a company to expand its advertising capabilities, a web page provides no mechanism for organizing or screening resumes that are received. The received resumes still must be organized and screened by a person in the company's human resources department in the traditional manner. Hence, there exits the possibility still that a resume will be overlooked or mishandled.

More recently, internet career websites have been developed, which connect companies providing job opportunities with potential job applicants. For job applicants, career websites offer a host of features, which typically include job listings, resume management, personal job search agents, chat and message boards, privacy options, expert advice and career management. Because different jobs may be posted on different career websites, individuals typically make use of more than one career website to maximize their results. Each of the career websites, however, typically requires the user to login and enter job search criteria. Therefore, the user must repeat entering this information at each of the sites.

Software applications also have been developed that are designed to make job searching and the submission of a resume to multiple career websites easier for the individual. Typical applications connect users to multiple career websites over the Internet and allows them to submit their resumes online. Some applications even incorporate a job finder feature.

These software applications, however, have many draw backs. For instance, some software applications are not compatible with the format of some career websites, causing the user to purchase additional software to translate data into the career website's format. Also, in most instances, if the user finds a mistake on their resume, the user has to edit the resume on their computer and then resubmit the resume to the career websites through the application. In addition, usually the users can only do general job searches, and not focus on specific positions. Unfortunately, employers are left with the cumbersome task of sifting through myriads of resumes for qualified job candidates. To add to the frustration, employers have to tediously go through the resumes of job applicants who have already found jobs, because their resumes have not been removed from the career websites. Consequently, finding and selecting qualified applicants is ineffective.

Accordingly, a need exists for an improved method and system for selecting job applicants that is more efficient for both the employer and the job applicant. The present invention addresses such a need.

### SUMMARY OF THE INVENTION

An object of the invention is to solve at least the above problems and/or disadvantages and to provide at least the advantages described hereinafter.

The present invention provides advantages and improvements over prior methods of selecting and hiring job applicants because it enables an employer to efficiently determine the best qualified applicant for a job. The invention provides a business method that is uniquely structured as a system and method for selecting job applicants from various sources hosting or advertising job openings.

A first embodiment of the present invention is directed to a the method of selecting qualified job applicants from a source hosting or advertising job openings comprising: creating an audio, visual, printed or electronic file comprising information pertaining to a job opening; posting or advertising the job opening with a source; and sending an automated electronic response to a prospective job applicant that comprises a questionnaire that the job applicant completes and electronically submits or electronically forwards to an employer for employment consideration.

A second embodiment of the present invention is directed to a method of selecting qualified job applicants from a source hosting or advertising job openings comprising: creating an audio, visual, printed or electronic file comprising information pertaining to a job opening; posting or advertising the job opening with a source; instructing a job applicant, within the posting for the job opening, to visit the employer's web page on the Internet for information on the employer and the employer's hiring process; prompting the job applicant, within posting for the job opening the job opening, to send an electronic reply to the employer that indicates the job applicant's interest in the job opening; sending an automated electronic response to the job applicant that comprises a questionnaire that the job applicant completes and electronically submits or electronically forwards back to the employer; collecting and evaluating the responses to the questionnaire; selecting the job applicant for an interview based on the responses to the questionnaire; notifying the job applicant of the job applicant's selection for an interview; assigning at least one task for the job applicant to perform for further employment consideration; evaluating the completion of the at least one task; and selecting the job applicant for the posted or advertised job opening, based on the quality and completion of the at least one task.

A third embodiment of the present invention is directed to a method of selecting qualified job applicants from a source hosting or advertising job openings comprising: creating an audio, visual, printed or electronic file comprising information pertaining to a job opening; posting or advertising the job opening with a source; instructing a job applicant, within the information pertaining to the job opening, to visit the employer's web page on the Internet for information on the employer and the employer's hiring process; prompting the job applicant, within the information pertaining to the job opening, to send an electronic reply to the employer that indicates the job applicant's interest in the job opening; sending an automated electronic response to the job applicant that comprises a questionnaire that the job applicant completes and electronically submits or electronically forwards back to the employer; collecting and evaluating the job applicant's responses to the questionnaire; evaluating the completion of the at least one task; and selecting the job applicant for an interview based on the responses to the questionnaire.

A fourth embodiment of the present invention is directed to a method of selecting a job applicant for an interview comprising: notifying the job applicant of the job applicant's selection for an interview; assigning at least one task for the job applicant to perform for employment consideration; evaluating the completion of the at least one task; and selecting the job applicant a job opening, based on the quality and completion of the at least one task.

A fifth embodiment of the present invention is directed to a method of selecting qualified job applicants from a source hosting or advertising job openings comprising each of two stages comprising: a pre-screening/qualifying stage, wherein a job applicant is evaluated by responses the job applicant gives to a questionnaire, based on an advertised job opening; and an interview stage, wherein the job applicant is selected for employment based the quality, performance, and completion of at least one task pertaining to the advertised job position.

A sixth embodiment of the present invention is directed to a method of selecting qualified job applicants from a source hosting or advertising job openings, comprising each of two stages comprising: a pre-screening/qualifying stage, wherein a job applicant is evaluated by responses given to a questionnaire, based on an advertised job opening; and a task instructing stage, wherein an employer assigns at least one task for the job applicant to complete and employment is determined by the quality and completion of the at least one task.

A seventh embodiment of the present invention is directed to an automated system for collecting and assessing job applicant information comprising: a posting unit for advertising a job opening; an auto response unit for responding to an interested job applicant, comprising sending an auto response questionnaire to the job applicant for inputting information; and an evaluation unit for assessing the qualifications of the job applicant based on the job applicant's response to the questionnaire.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block-flow chart diagram illustrating the general method for selecting qualified job applicants in the present invention.

FIG. 1A is a block-flow chart diagram illustrating detailed components of the method for selecting qualified job applicants in the present invention.

FIG. 1B is a block-flow chart diagram illustrating the components of sending an automated response with a questionnaire in the present invention.

FIG. 2 is a block-flow chart diagram illustrating the components of selecting a job applicant for an interview in the present invention.

FIG. 3 is a block-flow chart diagram illustrating the components of selecting a job applicant for a job opening in the present invention.

FIG. 4 is a block-flow chart diagram illustrating stage 1 and stage 2 of the present invention.

FIG. 5 is a block diagram illustrating an automated system for collecting and assessing job applicant information.

### DETAILED DESCRIPTION OF PREFERRED EMBODIMENTS

The present invention relates to a system and method for selecting qualified job applicants from sources hosting or advertising job openings. The following description will enable one of ordinary skill in the art to make and use the present invention. The present invention is not intended to be limited to the embodiments shown, but is to be accorded the broadest scope consistent with the principles and features described herein.

It is also to be understood that the terminology used herein is for the purpose of describing particular embodiments only and is not intended to be limiting. As used in the specification and the appended claims, the singular forms “a,” “an,” and “the” include plural referents unless the contest clearly dictates otherwise. As used herein, the terms “prospective job applicant,” “job applicant,” “applicant,” and “user” are used interchangeably to refer to a person seeking a job or employment. As also used herein, the terms “host” and “employer” are used interchangeably to refer to an individual or company posting or advertising a job opening. However, a host does not necessarily include an employer, but instead may include an individual, company, or website owner hosting a job opening advertisement for an employer.

The invention will now be described by the preferred embodiments as shown in the figures.

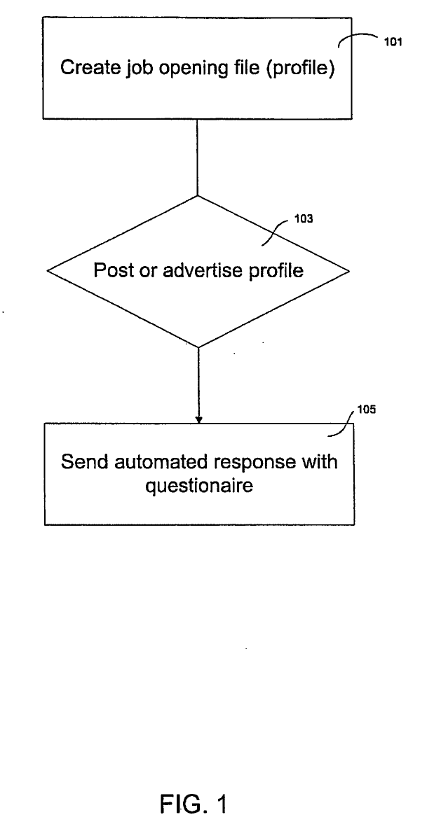

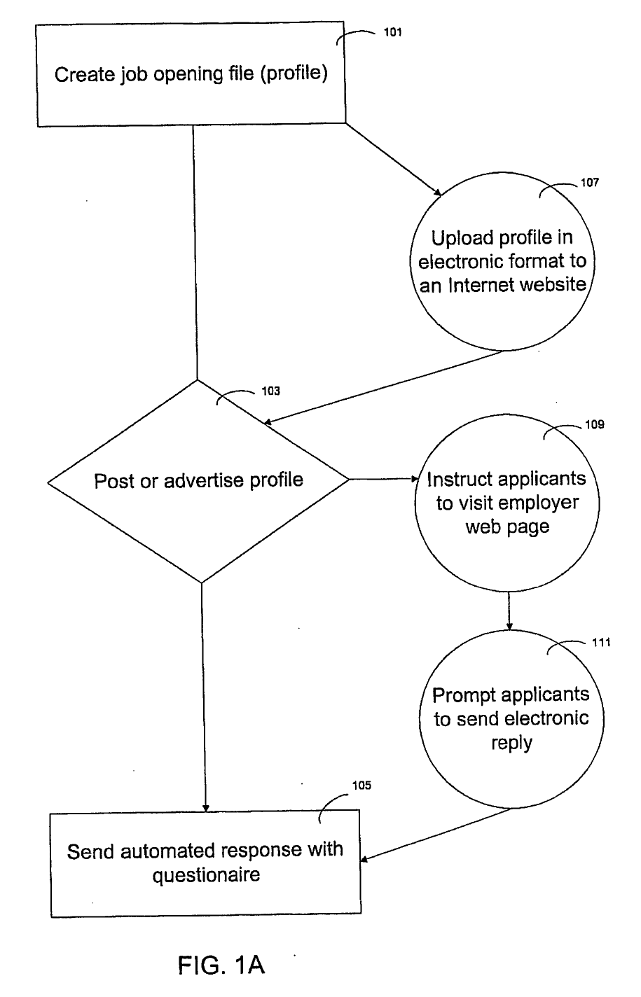

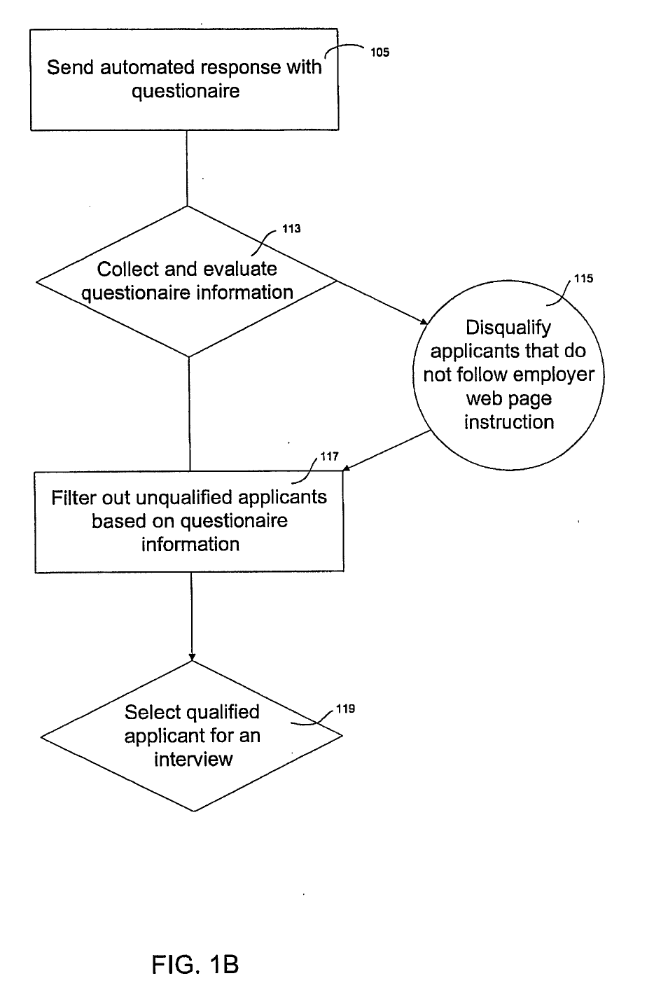

FIG. 1 is a block-flow chart diagram illustrating the general method for selecting qualified job applicants in the present invention, in accordance with a preferred embodiment of the present invention. In this preferred embodiment of the invention, a job opening is created as a file 101, which comprises information pertaining to a job opening and the employer having the job opening. The file, also referred to as a profile, may comprise technical or non-technical jobs, or both. The profile, as shown in Examples 1 and 2 below, may comprise a description of the job, the tasks involved in performing the job, the skills required for the job, a description of the employer's company, the advantages of working for the employer, the general location of the job, the compensation, and instructions to visit the employer's web page on the Internet.

In a preferred embodiment, the profile is posted or advertised 103 with a source. The source may comprise print, visual, electronic media or a combination of two or more thereof. The print, visual, or electronic media may comprise television, cable, satellite, radio, the Internet or a combination of two or more thereof. In certain preferred embodiments, the electronic media may comprise websites or web pages, and the websites or web pages comprise career websites or general advertisement websites, such as CraigsList or any web-based career bulletin board.

In another preferred embodiment, the employer or host of the source sends an automated electronic response 105 to a prospective job applicant that comprises a questionnaire that the job applicant completes and electronically submits or electronically forwards to the employer or host for employment consideration. The questionnaire may comprise basic information about the prospective job applicant's contact information, such as, but not limited to, a name, address, and telephone number. In certain embodiments, the questionnaire comprises specific questions pertaining to the job applicant's knowledge, background, and understanding of the nature of the job in the profile. The questions in the questionnaire may comprise open-ended questions that the job is expected to provide complete written answers or something of the like, to prove the job applicant's qualifications for the job. Alternatively, the questions in the questionnaire may comprise a series or multiple choice or true/false questions to provide proof of the job applicant's qualifications for the job.

FIG. 1A is a block-flow chart diagram illustrating the detailed components of the method for selecting qualified job applicants, in accordance with a preferred embodiment of the present invention. In this preferred embodiment of the invention, the job profile 101 is uploaded in electronic format to an Internet website 107. For example, the file is a computer readable file loaded on a job advertising website that is accessible via the world wide web, at any time in any location where Internet access is available, and is readable in any web browser, such as Internet Explorer, computer application, such as Microsoft Word, or any other computer medium.

In another preferred embodiment, the posted or advertised profile 103 provides instructions for the job applicant to visit the host or employer's web page 109. The web page contains information regarding the hiring process and background information on the host or employer. The profile also prompts the job applicant to send the employer or host an electronic reply 111 to signal that the job applicant is interest in pursuing the employment opportunity described in the profile. Once the job applicant's electronic reply is received, an automated response is sent to the job applicant. The automated response 105, as described above, contains a questionnaire that the applicant completes and electronically forwards back to the host or employer. In certain embodiments, the automated response clarifies and explains the nature of the job opening.

FIG. 1B is a block-flow chart diagram illustrating the detailed components of sending an automated response with a questionnaire 105, in accordance with a preferred embodiment of the present invention. In this preferred embodiment, an automated response 105 is sent to a job applicant that sends an electronic reply to the job opening profile. After this reply is received by the host or employer, the information is collected and evaluated 113. The information includes the job applicant's responses to the questionnaire, and may also include the job applicant's resume or any other relevant information the job applicant sends.

In another preferred embodiment, automated response will make clear that job applicants should not ask questions, and that job applicants will be disqualified 115 from further employment consideration who do not follow the employer web page instruction 109, as described above. For example, in responding to the automated response, job applicants that ask questions that are already answered or posted on the employer's web page will not be considered for the job opening.

In another preferred embodiment, unqualified applicants will be filtered out based on their responses to the questionnaire 117. Depending on the questionnaire format, only those applicants that fully answer the questions provided in the questionnaire and/or answer those questions accurately will be considered for employment. For example, the answers to the questions will have to demonstrate the applicant's knowledge or skill, or both. A sample of the type of auto response and questionnaire is provided in Example 3, shown below. In certain embodiments, the responses to questions may be measured against or compared with other applicants responding to similar questions.

In a preferred embodiment, a qualified applicant is selected for an interview 119 based on the responses to the questionnaire and any other information provided by the host or employer. In this context, the term qualified refers to someone who has demonstrated a high level competency, based on the questionnaire, for the job opening. The interview further determines this competency and how best qualified and compatible the job applicant will be for the job opportunity.

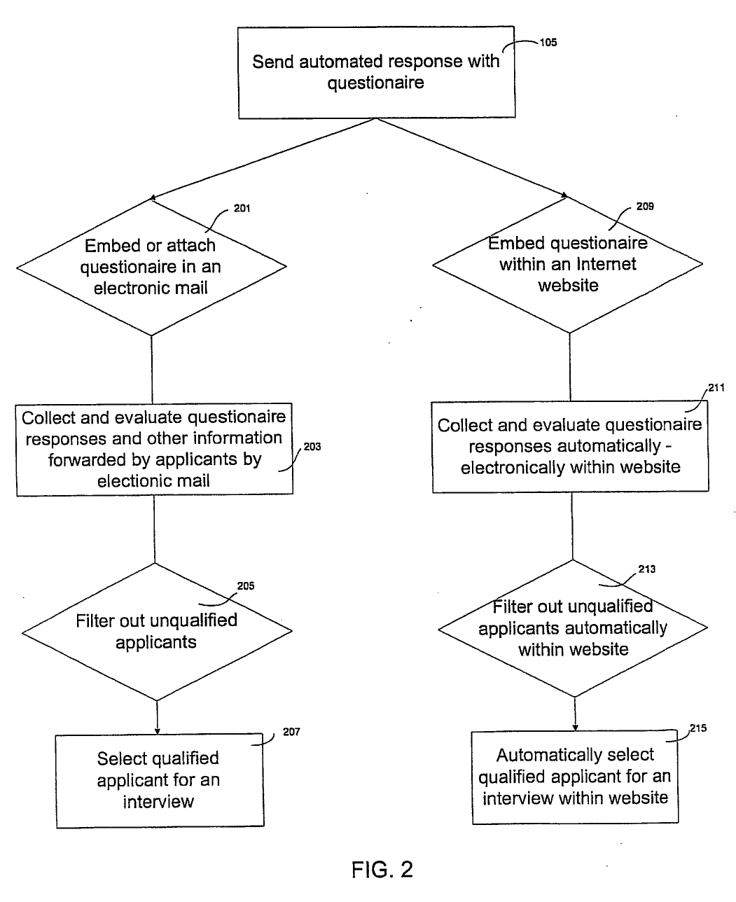

FIG. 2 is a block-flow chart diagram illustrating the components of selecting a job applicant for an interview, in accordance with a preferred embodiment of the present invention. In this preferred embodiment, as described above, the job applicant is sent an automated response with a questionnaire 105 to complete. In one embodiment, the automated response in embedded as a template in an electronic mail or attached to an electronic mail 201 as a computer readable file. The file attachment may comprise any word processor application, such as Microsoft Word, or readable format, such as Adobe Reader. In turn, the job applicant completes that questionnaire and sends it back to the employer or host electronically. The electronic submission may include the job applicant's resume or other relevant information, other than questions concerning the job opening. Then, the employer evaluates the responses to the questions 205, which may be measured against the responses of other prospective applicants, filters out unqualified applicants.

In a preferred embodiment, as described above, a qualified applicant is selected for an interview 207, based on the responses to the questionnaire and other information provided by the job applicant.

In another preferred embodiment, the questionnaire may be embedded in a website 209 and automatically appear on a computer screen after the job applicant submits an electronic reply, within the job profile, to indicate interest in the job opening. This format may contain a series of multiple choice or true/false questions that the applicant can respond to directly on the website by “clicking on” or selecting among a series of possible responses. In addition, or alternatively, there may a space within the questionnaire for typing in responses to certain questions, a space for adding comments, and/or area to add or upload a file attachment, such as a resume. Upon completely of the questionnaire, the applicant may electronically submit the responses within the website. Depending on the format of the questions, the website may be formatted or configured to automatically evaluate the responses 211 by tabulating a score. The website may determine the applicant's qualification for an interview 215, and submit an automatic on screen reply to the qualified applicant.

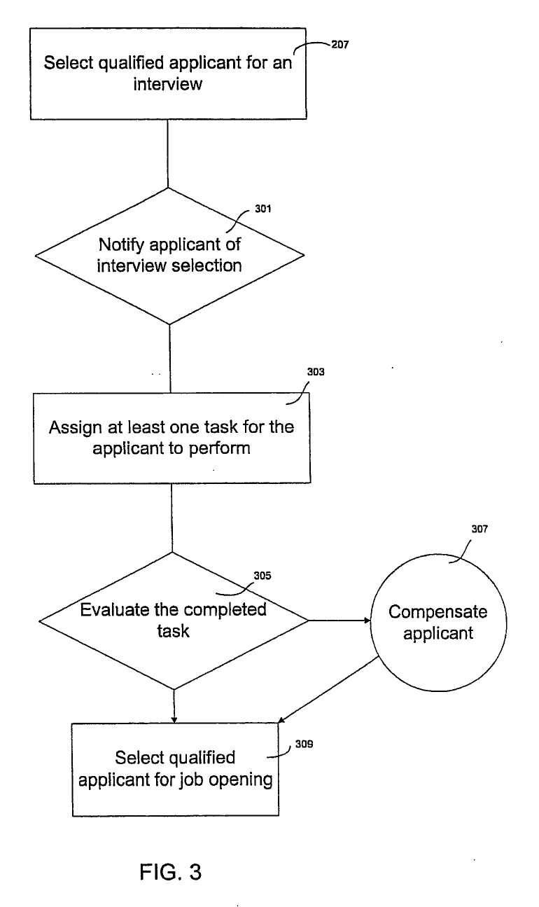

FIG. 3 is a block-flow chart diagram illustrating the components of selecting a job applicant for a job opening, in accordance with a preferred embodiment of the present invention. In this preferred embodiment, a qualified applicant is selected for an interview 207, as determined by one of the methods described above.

In one embodiment, the applicant is notified 301 automatically after completing a questionnaire that is embedded within a website hosting or advertising a job opening. In another embodiment, the job applicant is notified via electronic mail or other suitable means, such as regular mail, telephone, or facsimile transmission, of the job applicant's selection for an interview.

In another preferred embodiment, once notified, the applicant is assigned at least one task to perform 303 that relates to the job opening. The task may be performed independently, jointly, or as part of a competition to win the job. Further, the task may involve a presentation or report, which may be delivered in person at the employer's location or remotely.

In another preferred embodiment, the task is evaluated 305 by the employer for the quality, performance, and completion of the task. In certain preferred embodiments, the applicant may be compensated 307 for their time and efforts in completing the task, depending on the type and quantity of tasks performed.

A qualified applicant, in a preferred embodiment, is selected for the job opening 309, depending on the outcome of the task completion. The new employee is notified directly, in person after completing the task, or indirectly sometime later.

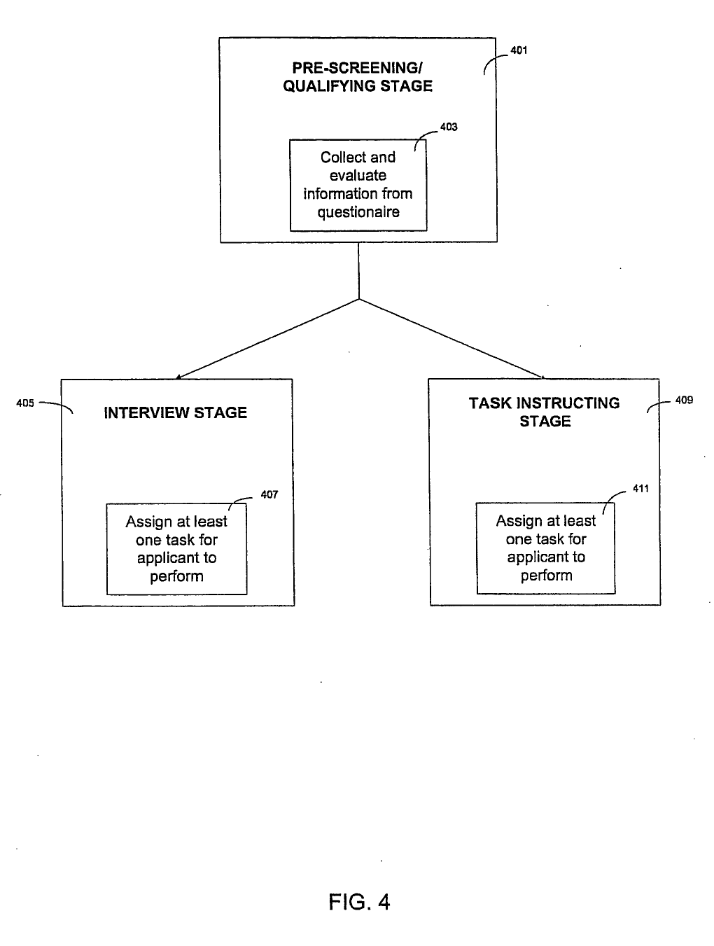

FIG. 4 is a block-flow chart diagram illustrating stages 1 and 2, in accordance with a preferred embodiment of the present invention. In a preferred embodiment, stages 1 and 2 represent all of the above described methods divided into two phases of a hiring process. For instance, stage 1 represents a pre-screening/qualifying stage 401, also known as the initial stage of the hiring process. In this initial stage, a job applicant is evaluated by responses given to a questionnaire 403. The questionnaire is based on an advertised job opening, and as described above, contains questions that access the job applicant's competency. The information is collected and evaluated by the host or employer and a determination is made on the job applicant's qualification for the job opening.

In another preferred embodiment, stage 2 represents an interview stage 405 or task instructing stage 409, and is also known as the second stage of the hiring process. In this second stage, and an employer assigns at least one task for the job applicant to complete 407 and 409 and employment is determined by the quality and completion of the at least one task.

Both of the two stages are described on the host's or employer's website, in which the job applicant is instructed to read before submitting comments or responses to the questionnaire in the automated response.

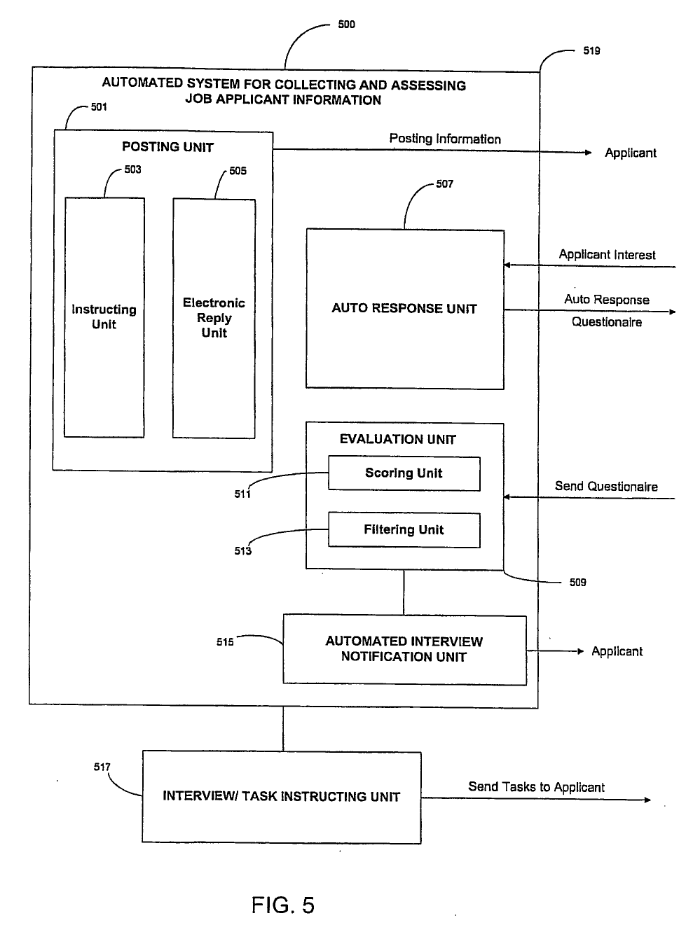

FIG. 5 is a block diagram illustrating an automated system for collecting and assessing job applicant information 500, in accordance with a preferred embodiment of the present invention. In one preferred embodiment, the system comprises a posting unit 501. The posting unit 501 comprises a suitable means for posting information for a prospective job applicant concerning a job opening. For instance, the suitable means may comprise print, visual, electronic media, such as television, cable, satellite, radio, the Internet or a combination them. In preferred embodiments, the posting unit comprises an electronic file posted to websites or web pages as a profile of the job opening.

In certain other preferred embodiments, the posting unit comprises an instructing unit 503 and an electronic reply unit 505. The instructing unit 503 comprises a means for directing the applicant to read and review the contents of the host's or employer's web page, which describes the details of the hiring process. For instance, instructions may be posted any where in the profile, including multiple locations in the profile. The instructions may be written or contained in an animated and/or audio electronic format. In other words, the web page may be interactive for the user. The electronic reply unit 505 comprises a suitable means for the job applicant to send a reply to the host or employer to indicate an interest in the job opening. Suitable means for the electronic reply include a direct electronic communication to the host or employer, such as electronic mail. Alternatively, the electronic means may be an electronic communication, configured within the website without direct notification to the host or employer, that is responded within the website.

In another preferred embodiment, the system comprises an auto response unit 507. For instance, once the job applicant submits a reply to indicate interest in the job opening, the auto response unit enables a suitable means for sending an auto response to the interest job applicant. The suitable means may include an automatic response 507 configured in a website that hosts the job opening that sends a direct-immediate response to the applicant within the website. Alternatively, the suitable means may be an electronic mail from the host or employer. In either situation, it is understood that the auto response 507 includes a questionnaire that the job applicant completes and electronically forwards back via electronic mail or electronically submits within the website.

In another preferred embodiment, the system comprises an evaluation unit 509 for assessing the qualifications of the job applicant, based on the job applicant's response to the questionnaire. In certain preferred embodiments, the evaluation unit 509 comprises a suitable means for evaluating the responses, such as a scoring unit 511 and a filtering unit 513. The scoring unit 511 may include, depending on the format of the questionnaire, an automatic-electronic determination of correct answers to question on the questionnaire. Once the answers are quantified, the filtering unit 513 includes a suitable means for determining which applicants are qualified for a interview and which are unqualified, such tabulating the results of the scoring unit 511. Alternatively, the suitable means may include a non-electronic evaluation of the questionnaire, such as manually reviewing and filtering of the responses by the host or employer.

In another preferred embodiment, the system comprises an automated interview notification unit 515. This unit includes a suitable means, such as an electronic mail, that sends the qualified job applicant notification of his or her selection for an interview.

In another preferred embodiment, the entire automated system 519, in addition to the system components described above, comprises a separate interview/task instructing unit 517 for sending tasks to the job applicant to complete for final employment consideration.

### EXAMPLES

### Example 1

The following is an example of a job opening profile for an analyst, a technical job, according to a preferred embodiment of the present invention.

SEEKING: Analyst: Motivated, Smart and Ready To Work!

Reply to: (the e-mail address of XYConcepts)

Date: (job posting date)

XYconcepts is seeking an analyst to underwrite and analyze potential investment opportunities for possible acquisitions, funding, joint venture and partnership. XYconcepts is a young, rapidly growing firm that is part LBO, Private Equity and Incubator. Our family of companies currently has over $100 million in assets. To learn more about our hiring process, please visit the website of XYconcepts

Duties Include:

Underwriting and analyzing a $50 million portfolio of apartments for acquisition

Develop a SWAT analysis for an industry we are looking at.

Call 50 potential customers of a company we are thinking of buying.

Presenting an investment opportunity to institutional partners.

Research creating a captive insurance company for insuring the properties.

Working Environment:

Small firm—get amazing experience and work with the top management.

We have fun

Food (and often beer) in the refrigerator

We have amazing office space in Shirlington, Va., just outside DC

Lots of opportunity for growth

Skills Required:

You must be an EXCEL GURU. Macros, complex formula, nothing is too intricate—push the envelope

Highly developed written and verbal communication skills—your analysis will be presented to senior management, institutional investors and Wall Street investment banks

Overly organized—You will be expected to work on several projects simultaneously. Also, you will need to develop processes for organizing projects.

Light overnight travel.

You must be willing to work late when it is required You must be able to tackle any project, even if you don't know where to start. Basically, you'd be doing some challenging work, which will require you to be resourceful and creative. You would very likely be meeting some very big players in the financial world both in DC and nationally. If you already have relevant experience . . . great but not required. But you must have a background in finance or accounting. A degree in one or both is preferred, but not required. Telecommunicating a day or two a week is possible. Let us re-iterate: it is very important that you are the type of person that likes tackling a problem where you don't even know where to start. If that kind of scares you, this is not the job for you.

PLEASE be sure to read, then re-read the information at the website of XYConcepts. We don't like people that can't follow directions. If you're interested, drop us a line and tell us why you're the person for this job.

COMPENSATION: Negotiable

HIRING ORGANIZATION: XYconcepts, LLC

Principals only. Recruiters, please don't contact this job poster.

Please, no phone calls about this job!

Please do not contact job poster about other services, products or commercial interests.

Reposting this message elsewhere is NOT OK.

This is in or around Shirlington, Va.

### Example 2

The following is an example of a job opening profile for an Gallery Director, a non-technical job, according to a preferred embodiment of the present invention.

SEEKING: Art Gallery Senior Sales Consultant

Reply to: (email address of XYconcepts)

Date: (job posting date)

[Name of Art Gallery] is a large and unique gallery representing the original works of contemporary European Impressionists. Our goal is to make it easier and more enjoyable to buy and lease fine art by offering a constantly rotating inventory of original work. To learn more about our hiring process, please visit the website of XYconcepts.

Overall Responsibilty:

This is a full-time, salaried management position. The job entails sales management, artist recruitment and relations. The senior sales consultant is responsible for the development, maintenance, execution and stewardship of the art gallery's unique vision and identity.

Duties Include:

Sales: Set and meet sales goals, manage all aspects of sales function, train and motivate staff, ensure exceptional customer experience.

Art and Community: Curate and install monthly shows at two galleries, develop corporate/business leasing and purchasing of art work, develop and train sales consultants, and develop off-site telephone sales system.

HR/Administration: Payroll, administer employee benefits package, maintain personnel files, manage staff including all hiring, scheduling, training.

Gallery Operations: Willingly assume full responsibility for all other gallery operations (technology, client inquiries, contracts, etc. . . .).

Qualifications Include:

Demonstrated sales management experience, preferably in a retail and/or art environment.

Knowledge of and passion for both fine art and art history.

A sense of community and familiarity with the metropolitan D.C. area arts scene.

A high level of comfort managing a team within an unstructured environment.

Outstanding verbal and written communication skills.

Leadership, initiative, creativity, enthusiasm and insight.

Effective interpersonal, negotiation and conflict resolution skills

A clear understanding and commitment to the art gallery's mission, values and unique placement in the art world.

PLEASE be sure to read, then re-read the information at the website of XYConcepts. If you're interested, drop us a line and tell us why you're the person for this job.

BENEFITS: Benefits include medical, dental, 401 (k).

COMPENSATION: Negotiable

HIRING ORGANIZATION: XYconcepts, LLC

Principals only. Recruiters, please don't contact this job poster.

Please, no phone calls about this job!

Please do not contact job poster about other services, products or commercial interests.

Reposting this message elsewhere is NOT OK.

This is in or around the northern Virginia area.

### Example 3

The following is an example of a standard automated response that the employer may send to a job applicant that has e-mailed the employer to express interest in the Analyst job, shown in Example 1.

Job Applicant (Applicant's First Name Inserted Here), thanks for your interest in this position.

This is a semi-templated e-mail, so please excuse the impersonal nature. We'll get much more personal as we go through the hiring process, if your skill is a match for our firm. At this point, I have only glanced through your e-mail and if you included a resume, I have not read it yet. I have some questions below, which I am asking all candidates, because these will allow us to better understand how well you will fit into our organization. If you have already answered any of these questions, feel free to reiterate your original response. Our posting and hiring process is quite unique. You are at stage one of this process.

For this analyst position, for example, a big part of it is dissecting companies. This analyst is going to have to be able to take a look at an opportunity that comes in and tell us how good of an investment it might be. The major tool they use is Excel, so we need somebody who is good with Excel. The first question is: “Have you used Excel much?” Prove to us that you are the baddest Excel guru out there. You may choose to attach the most complex spreadsheet you've ever done, removing personal and confidential information or you may choose to impress us with some crazy macros or formulas you have created. Just do whatever you feel necessary to prove that you know your stuff

The second questions is: “Do you know how to analyze a business within a market?” Prove it.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of selecting qualified job applicants from a source hosting or advertising job openings, the method comprising:
creating an audio, visual, printed or electronic file comprising information pertaining to a job opening;
posting or advertising the job opening with a source; and
automatically sending an electronic response to a prospective job applicant's inquiry that comprises a questionnaire that the job applicant completes and electronically submits or electronically forwards to an employer for employment consideration.

2. The method of selecting qualified job applicants from a source hosting or advertising job openings according to claim 1, wherein the source comprises print, visual, electronic media or a combination of two or more thereof.

3. The method of selecting qualified job applicants from a source hosting or advertising job openings according to claim 2, wherein the print, visual, or electronic media comprises television, cable, satellite, radio, the Internet or a combination of two or more thereof.

4. The method of selecting qualified job applicants from a source hosting or advertising job openings according to claim 2, wherein the electronic media comprises websites or web pages or information contained in one or more websites or one or more web pages.

5. The method of selecting qualified job applicants from a source hosting or advertising job openings according to claim 4, wherein the websites or web pages comprise career websites or general advertisement websites.

6. The method of selecting qualified job applicants from a source hosting or advertising job openings according to claim 1, further comprising instructing a job applicant, within the posting for the job opening, to visit the employer's web page on the Internet for information on the employer and the employer's hiring process.

7. The method of selecting qualified job applicants from a source hosting or advertising job openings according to claim 1, further comprising prompting the job applicant, within posting for the job opening the job opening, to send an electronic reply to the employer that indicates the job applicant's interest in the job opening.

8. The method of selecting qualified job applicants from a source hosting or advertising job openings according to claim 1, further comprising embedding the questionnaire as a template in a an electronic mail.

9. The method of selecting qualified job applicants from a source hosting or advertising job openings according to claim 1, further comprising automatically generating the questionnaire as a template within the website posting the job opening, after the electronic reply is submitted by the job applicant.

10. The method of selecting qualified job applicants from a source hosting or advertising job openings according to claim 1, wherein the job applicant's response to the questionnaire includes the job applicant's resume.

11. The method of selecting qualified job applicants from a source hosting or advertising job openings according to claim 1, further comprising disqualifying a job applicant who electronically mails the employer with inquiries or questions that are already answered on the employer's web page.

12. The method of selecting qualified job applicants from a source hosting or advertising job openings according to claim 1, wherein the automated response clarifies and explains the job position in the job opening file.

13. The method of selecting qualified job applicants from a source hosting or advertising job openings according to claim 1, wherein the task comprises a presentation.

14. The method of selecting qualified job applicants from a source hosting or advertising job openings according to claim 1, wherein the file comprises a specific profile of the job opening.

15. The method of selecting qualified job applicants from a source hosting or advertising job openings according to claim 14, wherein the profile comprises technical or non-technical jobs.

16. The method of selecting qualified job applicants from a source hosting or advertising job openings according to claim 14, wherein the profile comprises a description of the job, the tasks involved in performing the job, the skills required for the job, a description of the employer's company, the advantages of working for the employer, the general location of the job, the compensation, and instructions to visit the employer's web page on the Internet.

17. A method of selecting qualified job applicants from a source hosting or advertising job openings, the method comprising:
a pre-screening/qualifying stage, wherein a job applicant is evaluated by responses given to a questionnaire, based on an advertised job opening; and
a task instructing stage, wherein an employer assigns at least one task for the job applicant to complete and selects qualified job applicants based on the completion of the at least one task.

18. A method of selecting qualified job applicants from a source hosting or advertising job openings according to claim 17, further comprising embedding the questionnaire as a template in an electronic mail.

19. A method of selecting qualified job applicants from a source hosting or advertising job openings according to claim 17, further comprising automatically generating the questionnaire as a template within the website posting the job opening, after the electronic reply is submitted by the job applicant.

20. An automated system for collecting and assessing job applicant information, the system comprising:
a posting unit for advertising a job opening;
an auto response unit for responding to a job applicant, comprising sending an auto response questionnaire to the job applicant for inputting information; and
an evaluation unit for assessing the qualifications of the job applicant based on the job applicant's response to the questionnaire.
